(19) United States
(12) Patent Application Publication
(10) Pub. No.: US 2006/0032048 A1
(43) Pub. Date: Feb. 16, 2006

(54) Press-connecting head of press-connecting pliers for coaxial terminal

(75) Inventors: Chien-Chou Liao, Taipei Hsien (TW); Chih-Lang Wang, Taipei Hsien (TW)

Correspondence Address: BACON & THOMAS, PLLC, 625 SLATERS LANE, FOURTH FLOOR, ALEXANDRIA, VA, 22314, US

(73) Assignee: HANLONG INDUSTRIAL CO., LTD., Taipei Hsien (TW)

(21) Appl. No.: 10/916,393

(22) Filed: Aug. 12, 2004

(51) Int. Cl. B23P 19/00

(52) U.S. Cl. 29/750

(57) ABSTRACT

The press-connecting head comprises three elements including a pressing rod, a die core and a rotation cap; wherein the pressing rod is provided on the press-connecting head at a position in corresponding to a fixed die block of the press-connecting head, and has centrally thereof an axial hole for receiving the die core; the rotation cap is slipped over the front end of the pressing rod and is rotatable relative to the pressing rod, and has on the inner side thereof a thread to engage with the front end of the die core; when the rotation cap is rotated, the die core displaces and protrudes from the front end of the pressing rod or is hidden in the rotation cap. When in use, the pressing rod is displaced relative to the die block to press connect a coaxial terminal with a coaxial wire; by displacement and adjustment of the die block, the pliers can suit coaxial terminals of different specifications.

### BACKGROUND OF THE INVENTION

1. Field of the Invention

The present invention is related to a press-connecting head of a pair of press-connecting pliers for a coaxial terminal, and especially to an improved structure of a press-connecting head of a pair of press-connecting pliers; by a simple rotation action, the press-connecting head can suit coaxial connecting respectively of a BNC type coaxial terminal, an RCA type coaxial terminal and an F type coaxial terminal with a coaxial signal line, thereby the range of application of a pair of press-connecting pliers can be enlarged.

2. Description of the Prior Art

As shown in FIGS. 1-3 that are drawings showing the types of various normally used coaxial terminals for coaxial signal lines at the present time; the types of terminals at least include the F type coaxial terminal shown in FIG. 1, the BNC type coaxial terminal shown in FIG. 2 and the RCA type coaxial terminal shown in FIG. 3. Wherein the difference among these types of coaxial terminals mainly is due to the compliance with equipment they are to connect, thus different types of connectors are formed. However basically, the connecting structure for coaxial signal lines does not have any evident change; similarly, the coaxial signal lines are directly press fixed on the tailing ends of the coaxial terminals by direct pressing in for connecting.

A pair of press-connecting pliers used to press connect a coaxial signal line with a coaxial terminal are provided with a set of fixed die block and a set of press-connecting head; when the coaxial terminal and the tailing end of the coaxial signal line are placed between the fixed die block and the press-connecting head of the of press-connecting pliers, handles are pressed to render the press-connecting head to move toward the fixed die block, then the coaxial terminal and the coaxial signal line can be pressed and fixed.

However, coaxial terminals stated above at least include the RCA type coaxial terminals, the BNC type coaxial terminals and the F type coaxial terminals, they are very different by appearance as are the shapes shown in FIGS. 1-3. For example, the F type coaxial terminal 10 shown in FIG. 1 is of the shape having a slip-connecting hole 11 provided on its end, while the BNC type coaxial terminal 20 and the RCA type coaxial terminal 30 shown in FIGS. 2, 3 are of the shape having protruding insertion-connecting members 21, 31 respectively, and the protruding insertion-connecting member 21 of the BNC type coaxial terminal 20 shown in FIG. 2 is shorter having a hole centrally, so that a press-connecting head used on a pair of conventional press-connecting pliers for coaxial terminals can only allow press connecting of a single coaxial terminal; and thereby the press-connecting pliers are limited in their range of application.

### SUMMARY OF THE INVENTION

The press-connecting head of a pair of press-connecting pliers for a coaxial terminal of the present invention basically is composed of three elements including a pressing rod, a rotation cap and a die core; wherein the pressing rod is provided on the press-connecting head at a position in corresponding to a fixed die block of the press-connecting head, and is provided centrally thereof with an axial hole for receiving the die core; the rotation cap is slipped over the front end of the pressing rod and is rotatable relative to the pressing rod, and is provided on the inner side thereof with a thread to engage with the front end of the die core; the front end of the die core has a through hole facing to the end of the die block, the front end of the rotation cap has a recessed seat also facing to the end of the die block.

Thereby, when the rotation cap is rotated, the die core screw connected with it displaces and protrudes from the front end of the pressing rod or is hidden in the rotation cap. When the entire press-connecting head forms the style in which the die core protrudes out of the front end of the rotation cap, an F type coaxial terminal can be extended in a slip-connecting hole by means of the die core and thereby is positioned. When the entire press-connecting head forms the style in which the die core is hidden in the rotation cap, an end of a BNC type coaxial terminal can be slipped in the recessed seat and thereby the BNC type coaxial terminal is positioned; alternatively, an insertion-connecting member of an RCA type coaxial terminal can be extended into the through hole of the die core and thereby the RCA type coaxial terminal is positioned.

Hence the die core of the press-connecting head can be displaced by a simple rotating action of the rotation cap to make the press-connecting head suitable for positioning coaxial terminals of different specifications. When a user manipulates the press-connecting pliers to displace the press-connecting head toward the fixed die block, any type of the above mentioned coaxial terminals can be press connected with a coaxial signal line and fixed thereon; thereby the range of application of a pair of press-connecting pliers can be enlarged.

The present invention will be apparent in its combination of structure and its entire mode of operation after reading the detailed description of the preferred embodiment thereof in reference to the accompanying drawings.

### BRIEF DESCRIPTION OF THE DRAWINGS

FIG. 1 is a perspective view showing the appearance of a normally called F type coaxial terminal;

FIG. 2 is a perspective view showing the appearance of a normally called BNC type coaxial terminal;

FIG. 3 is a perspective view showing the appearance of a normally called RCA type coaxial terminal;

FIG. 4 is a perspective view showing the appearance of the press-connecting pliers of the present invention with their press-connecting head provided between an included angle of two handles;

FIG. 5 is an analytic perspective view showing the structure of the press-connecting head of the present invention;

FIG. 6 is a schematic sectional view of the press-connecting head of the present invention showing a die core being protruding out of the front end of a rotation cap for positioning of an F type coaxial terminal;

FIG. 7 is a schematic sectional view of the press-connecting head of the present invention showing a die core being hidden in a rotation cap for positioning of a BNC type coaxial terminal;

FIG. 8 is a schematic sectional view of the press-connecting head of the present invention showing a die core being hidden in a rotation cap for positioning of an RCA type coaxial terminal;

FIG. 9 is perspective view showing the appearance of the press-connecting pliers of the present invention with their press-connecting head provided outside of an included angle of two handles;

FIG. 10 is perspective view showing the appearance of another pair of press-connecting pliers of the present invention with their press-connecting head provided outside of an included angle of two handles.

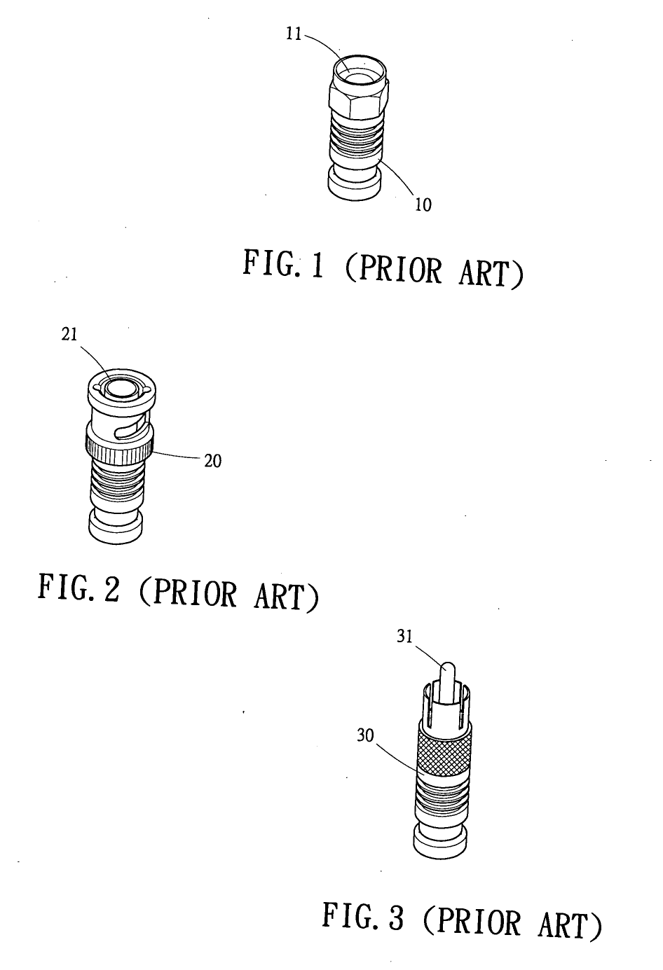

### DETAILED DESCRIPTION OF THE PREFERRED EMBODIMENT

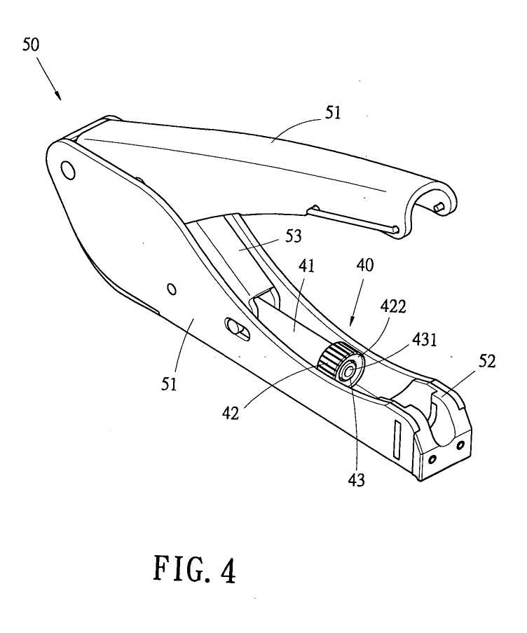

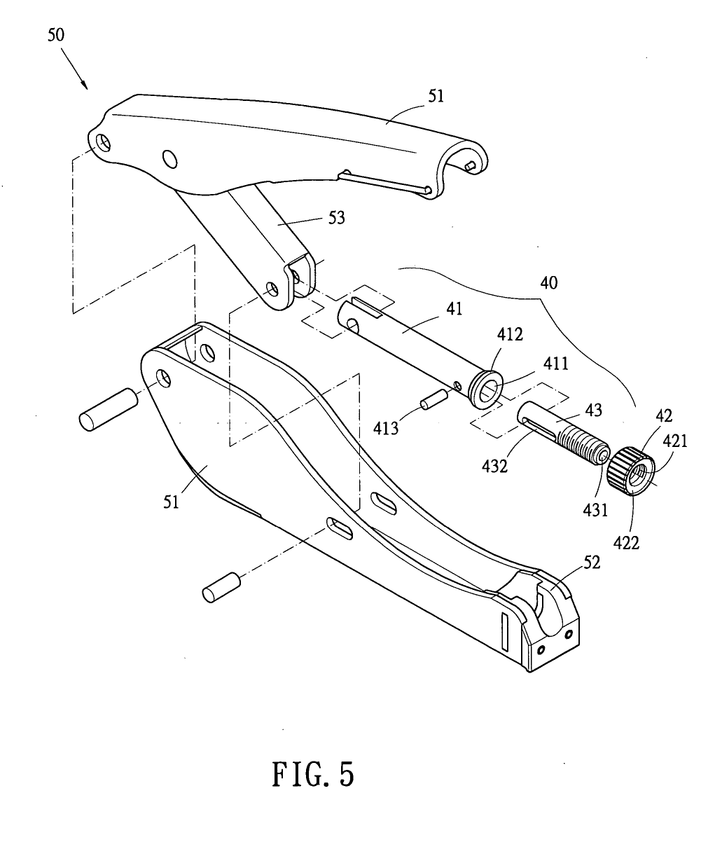

The basic structure of a press-connecting head 40 of a pair of press-connecting pliers for a coaxial terminal of the present invention is shown as in FIGS. 4 and 5, and mainly comprises a pressing rod 41, a rotation cap 42 and a die core 43. Wherein:

The pressing rod 41 is provided on the press-connecting pliers 50 at a position in corresponding to a fixed die block 52 of the press-connecting pliers 50, and is provided centrally thereof with an axial hole 411 for receiving the die core 43;

The rotation cap 42 is slipped over the front end of the pressing rod 41 and is rotatable relative to the pressing rod 41, and is provided on the inner side thereof with a thread 421 to engage with the front end of the die core 42.

The front end of the die core 43 has a through hole 431 facing to the end of the die block 52, the front end of the rotation cap 42 has a recessed seat 422 also facing to the end of the die block 52.

In the structural style of the press-connecting pliers 50 as shown in FIGS. 4 and 5, the press-connecting head 40 is allocated between an included angle of two handles 51, the entire pressing rod 41 of the press-connecting head 40 is pivotally connected with a link 53 of the press-connecting pliers 50, and form a kind of connection with and allowing sliding of one of the two handles 51; a fixing die block 52 is provided on the tailing end of this handle 51 for fixing a coaxial wire.

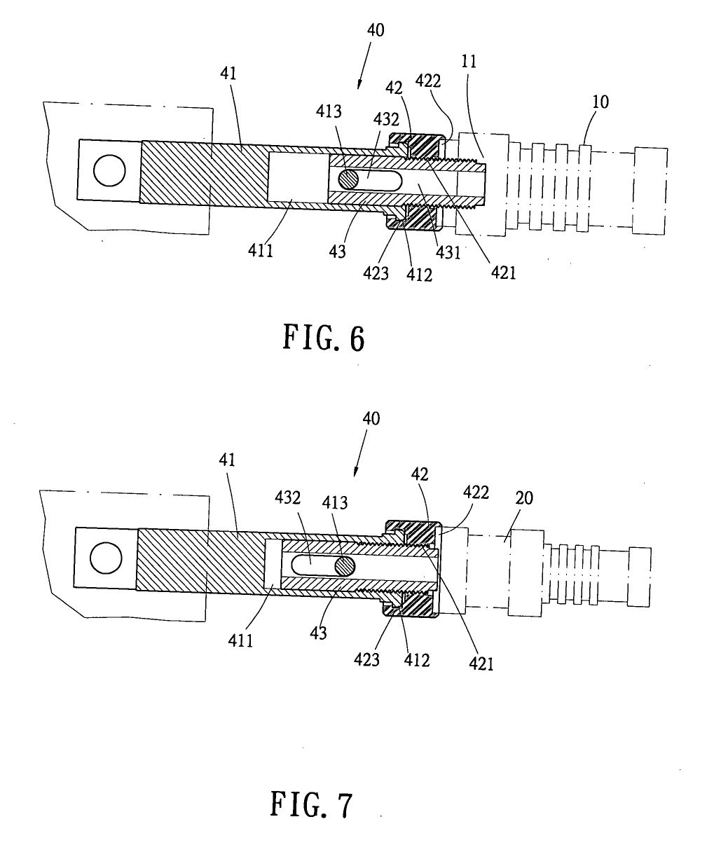

The rotation cap 42 is slipped over the pressing rod 41 and faces to the end of the die block 52, the pressing rod 41 has on its end slip connecting with the rotation cap 42 a protruding flange 412; as shown in FIG. 6, the protruding flange 412 is engaged in an annular recess 422 in the rotation cap 42 to form slipping-connection of the rotation cap 42 with the pressing rod 41, and the rotation cap 42 can rotate relative to the pressing rod 41.

And as shown in FIGS. 5-7, the die core 43 can be connected with an axial hole 411 of the pressing rod 41 and has an elongate slot 432 at the area it extends into the axial hole 411; and a pin 413 fixed on the pressing rod 41 is extended into the elongate slot 432, so that when the rotation cap 42 is rotated, the pin 413 can restrain rotation of the die core 43 without affecting advancing of the die core 43 following the thread 421, rather, the pin 413 is moved linearly to protrudes out of the front end of the rotation cap 42 or to hide in the rotation cap 42.

Thereby, when in practical use, by rotation of the rotation cap 42 as shown in FIG. 6, the die core 43 screw connected with the rotation cap 42 is displaced toward the front end of the rotation cap 42 to make the die core 43 protrudes out of the front end of the rotation cap 42, thereby the die core 43 can be used to extend into a slip-connecting hole 11 of an F type coaxial terminal 10 to make positioning of the F type coaxial terminal 10.

Or as shown in FIG. 7, the die core 43 can be hidden in the rotation cap 42 to allow an end of a BNC type coaxial terminal 20 to slip in the recessed seat 422 of the rotation cap 42 to make positioning of the BNC type coaxial terminal 20.

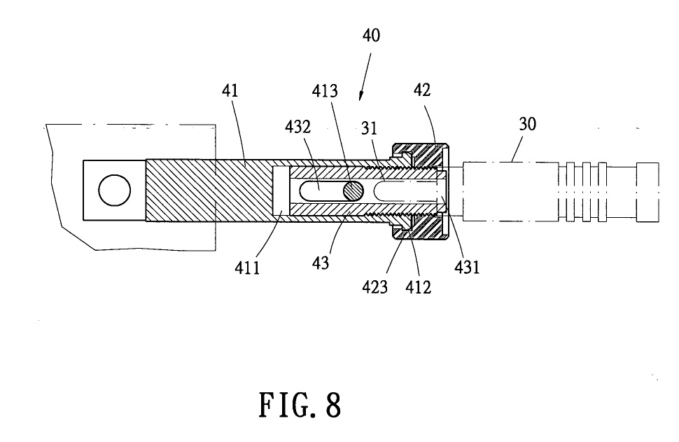

Or as shown in FIG. 8, in a type of structure that the die core 43 of the press-connecting head 40 is similarly hidden in the rotation cap 42, it can allow an insertion-connecting member 31 of an RCA type coaxial terminal 30 to extend into the through hole 431 of the die core 43 to surely make positioning of the RCA type coaxial terminal 30.

So that the die core 43 of the press-connecting head 40 can be displaced by a simple rotating action of the rotation cap 42 to make the press-connecting head 40 suit structures of coaxial terminals of different specifications. When a user manipulates the press-connecting pliers 50 to displace the press-connecting head 40 toward the fixed die block 52, any type of the above mentioned coaxial terminals can be press-connected with a coaxial signal line and fixed thereon; thereby the pair of press-connecting pliers 50 with the structure the press-connecting head 40 of the present invention can be used for operations of press connecting of coaxial terminals of different specifications with coaxial signal lines.

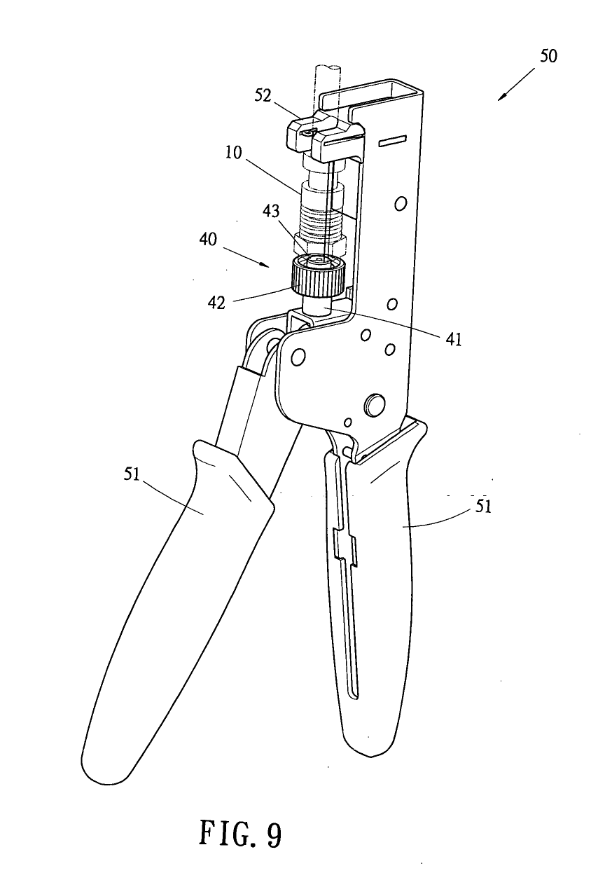

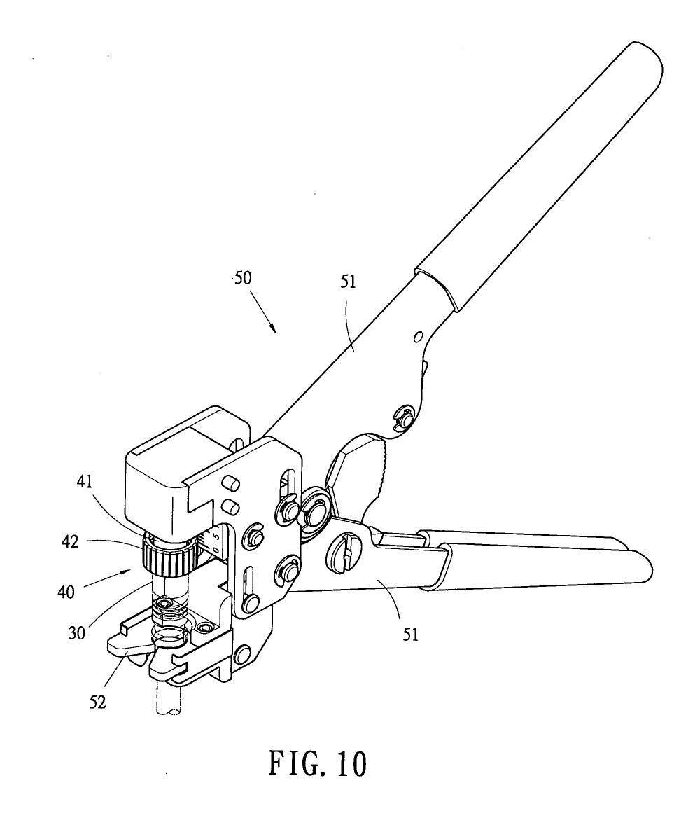

And more, in the embodiment shown in FIGS. 4-8, the press-connecting pliers 50 are of the style of holding and pressing and have their press-connecting head 40 provided between the included angle of two handles 51. Certainly, the press-connecting pliers 50 can also be in the style of structure to have their press-connecting head 40 provided, as shown in FIGS. 9 and 10, outside of the included angle of the two handles 51; likewise, the press-connecting pliers 50 take advantage of the action of the two pressing handles 51 to make the press-connecting head 40 and the fixed die block 52 to mutually get close, thereby the action mode of pressing and clamping for a coaxial terminal and a coaxial wire can be completed.

According to the description disclosed above, the present invention can change a press-connecting head into a structural style to suit a coaxial terminal to be press connected just by simple rotation of a rotation cap, thereby the range of application of the press-connecting pliers can be enlarged.

The embodiment and description given are only for illustrating the present invention and not for giving any limitation to the scope of the present invention. It will be apparent to those skilled in this art that various equivalent modifications or changes without departing from the spirit of this invention shall also fall within the scope of the appended claims.

Having thus described my invention, what I claim as new and desire to be secured by Letters Patent of the United States are:

1. A press-connecting head of a pair of press-connecting pliers for a coaxial terminal, said press-connecting head comprises:
a pressing rod provided on said press-connecting pliers at a position in corresponding to a fixed die block of said press-connecting pliers, said pressing rod is provided centrally thereof with an axial hole;
a rotation cap slipped over a front end of said pressing rod and being rotatable relative to said pressing rod, said rotation cap is provided on an inner side thereof with a thread;
a die core slip connected with an axial hole of said pressing rod, a front end of said die core is engaged with a thread of said rotation cap, when said rotation cap is rotated, said die core displaces and protrudes from a front end of said pressing rod or is hidden in said rotation cap.

2. The press-connecting head of a pair of press-connecting pliers for a coaxial terminal as defined in claim 1, wherein:
said pressing rod has on its end slip connecting with said rotation cap a protruding flange; said protruding flange is engaged in an annular recess in said rotation cap to form slipping-connection of said rotation cap with said pressing rod.

3. The press-connecting head of a pair of press-connecting pliers for a coaxial terminal as defined in claim 1, wherein:
said die core has an elongate slot at an area it extends into said axial hole, and a pin fixed on said pressing rod is extended into said elongate slot.

4. The press-connecting head of a pair of press-connecting pliers for a coaxial terminal as defined in claim 1, wherein:
said press-connecting head is provided between an included angle of two handles of said press-connecting pliers.

5. The press-connecting head of a pair of press-connecting pliers for a coaxial terminal as defined in claim 1, wherein:
said press-connecting head is provided outside of an included angle of two handles of said press-connecting pliers.

6. The press-connecting head of a pair of press-connecting pliers for a coaxial terminal as defined in claim 1, wherein:
said rotation cap has on its front end a recessed seat.

7. The press-connecting head of a pair of press-connecting pliers for a coaxial terminal as defined in claim 1, wherein:
said front end of said die core has a through hole.
